(19) United States
(12) Patent Application Publication
(10) Pub. No.: US 2018/0321430 A1
(43) Pub. Date: Nov. 8, 2018

(54) DISPLAY SUBSTRATE, MANUFACTURING METHOD THEREOF, DISPLAY PANEL

(71) Applicants: BOE TECHNOLOGY GROUP CO., LTD., Beijing (CN); BEIJING BOE DISPLAY TECHNOLOGY CO., LTD., Beijing (CN)

(72) Inventors: Xiaolong LI, Beijing (CN); Yupeng WANG, Beijing (CN); Chao TIAN, Beijing (CN); Hongshu ZHANG, Beijing (CN); Hong HE, Beijing (CN)

(21) Appl. No.: 15/755,514

(22) PCT Filed: Aug. 16, 2017
(86) PCT No.: PCT/CN2017/097609

§ 371 Date: Feb. 26, 2018

(30) Foreign Application Priority Data
Aug. 16, 2016 (CN) 201610675915.1

(51) Int. Cl. G02B 5/30; G02B 5/20; G09G 3/20

(52) U.S. Cl. CPC G02B 5/3025; G02B 5/28; G09G 3/2003; G02B 5/201

(57) ABSTRACT

The present disclosure discloses a display substrate, a manufacturing method thereof, and a display panel. The display substrate comprises: pixel regions corresponding to different wavelengths; and an optical film layer in a corresponding pixel region. For each pixel region, the optical film layer is configured such that light exiting from the pixel region has at least two different phases, and the at least two different phases cause light having a wavelength corresponding to the pixel region to interfere constructively, and light having other wavelengths to interfere destructively.

### RELATED APPLICATION

The present application claims the benefit of Chinese Patent Application No. 201610675915.1, filed on Aug. 16, 2016, the entire disclosure of which is incorporated herein by reference.

### FIELD

The present disclosure relates to the field of display technologies, and particularly to a display substrate, a manufacturing method thereof, and a display panel.

### BACKGROUND

With the development of display technologies, improving the color gamut of a display device has become a trend of the development of display technologies. However, the conventional manufacturing process of a display substrate is very complicated and the cost thereof is too high.

Therefore, how to decrease the difficulty in the manufacturing process of a display substrate, reduce the manufacturing cost thereof, and improve the color gamut of a display device is a technical problem to be solved urgently by those skilled in the art.

### SUMMARY

Embodiments of the present disclosure provide a display substrate, a manufacturing method thereof, and a display panel, which can at least partially alleviate or even eliminate the problems in the prior art.

Embodiments of the present disclosure provide a display substrate comprising: pixel regions corresponding to different wavelengths; an optical film layer in a corresponding pixel region. For each pixel region, the optical film layer is configured such that light exiting from the pixel region has at least two different phases, and the at least two different phases cause light having a wavelength corresponding to the pixel region to interfere constructively, and light having other wavelengths to interfere destructively.

In a possible implementation, in the above display substrate provided by embodiments of the present disclosure, the optical film layer covers only a part of the corresponding pixel region.

In a possible implementation, in the above display substrate provided by embodiments of the present disclosure, in each pixel region, the part covered by the corresponding optical film layer and a part not covered by the corresponding optical film layer are substantially equal in area.

In a possible implementation, the display substrate comprises a red pixel region, a green pixel region, and a blue pixel region.

The optical film layer corresponding to the red pixel region has a thickness of about 7 μm, the optical film layer corresponding to the green pixel region has a thickness of about 5.5 μm, and the optical film layer corresponding to the blue pixel region has a thickness of about 4.3 μm.

In a possible implementation, in the above display substrate provided by embodiments of the present disclosure, each pixel region comprises a plurality of sub-regions, and each sub-region is covered with a sub-optical film layer with a different thickness.

In a possible implementation, the differences in thickness between the sub-optical film layers corresponding to every two adjacent sub-regions are substantially the same.

In a possible implementation, in the above display substrate provided by embodiments of the present disclosure, the sub-regions are substantially equal in area.

In a possible implementation, the above display substrate provided by embodiments of the present disclosure further comprises: a black matrix surrounding each pixel region; and a protective layer covering the black matrix and each pixel region.

In a possible implementation, in the above display substrate provided by embodiments of the present disclosure, each pixel region is equally divided into five sub-regions, the sub-optical film layer corresponding to the first sub-region has a thickness of 0, and from the first sub-region to a fifth sub-region, the thicknesses of corresponding sub-optical film layers successively increase with a substantially constant step.

In a possible implementation, the above display substrate provided by embodiments of the present disclosure comprises a red pixel region, a green pixel region and a blue pixel region, wherein the refractive index of the optical film layer is n1, the refractive index of the protective layer is n0, and in the green pixel region, the thicknesses of the optical film layers covering the first sub-region to the fifth sub-region are 0, 1100 μm/|n1-n0|, 2200 μm/|n1-n0|, 3300 μm/|n1-n0|, and 4400 μm/|n1-n0|, successively.

In a possible implementation, in the above display substrate provided by embodiments of the present disclosure, each pixel region is equally divided into ten sub-regions, the sub-optical film layer corresponding to the first sub-region has a thickness of 0, and from the first sub-region to a tenth sub-region, the thicknesses of corresponding sub-optical film layers successively increase with a substantially constant step.

In a possible implementation, the above display substrate provided by embodiments of the present disclosure comprises a red pixel region, a green pixel region, and a blue pixel region, wherein the refractive index of the optical film layer is n1, the refractive index of the protective layer is n0, and in the green pixel region, the thicknesses of the optical film layers covering the first sub-region to the tenth sub-region are 0, 1100 μm/|n1-n0|, 2200 μm/|n1-n0|, 3300 μm/|n1-n0|, 4400 μm/|n1-n0|, 5500 μm/|n1-n0|, 6600 μm/|n1-n0|, 7700 μm/|n1-n0|, 8800 μm/n1-n0|, and 9900 μm/|n1-n0|, successively.

In a possible implementation, in the above display substrate provided by embodiments of the present disclosure, the refractive index of the optical film layer is about n1ₓ=1.27, n1_{y}=1.2, and the refractive index of the protective layer is about n1=1.3.

In a possible implementation, in the above display substrate provided by embodiments of the present disclosure, the sub-optical film layer has a shape selected from a group comprising a strip, a circle and a checkerboard.

In a possible implementation, in the above display substrate provided by embodiments of the present disclosure, the difference between refractive indexes of the optical film layer and the protective layer ranges from about 0.1 to 0.2.

In a possible implementation, in the above display substrate provided by embodiments of the present disclosure, the refractive index of the optical film layer is about 1.3, and the refractive index of the protective layer is about 1.2.

In a possible implementation, in the above display substrate provided by embodiments of the present disclosure, the optical film layer is a high molecular polymer having anisotropy.

In a possible implementation, the above display substrate provided by embodiments of the present disclosure further comprises a polarizer on a light emergent side of the display substrate. The polarizer is a wide viewing angle polarizer.

In a possible implementation, the above display substrate provided by embodiments of the present disclosure is a color filter substrate.

In a possible implementation, the above display substrate provided by embodiments of the present disclosure is an array substrate.

Embodiments of the present disclosure provide a display panel comprising any of the display substrates described above.

Embodiments of the present disclosure further provide a manufacturing method of the above display substrate provided by embodiments of the present disclosure, which comprises:

forming an optical macromolecular material layer on a base substrate;

assembling a template with the base substrate on which the optical macromolecular material layer is formed so that the template is embedded into the optical macromolecular material layer to form a pattern in the optical macromolecular material layer corresponding to the template;

applying a constant electric field to the optical macromolecular material layer via upper and lower electrodes so as to regularly orient a macromolecular material in the formed optical macromolecular material layer to form an anisotropic optical macromolecular material layer; and

UV curing the anisotropic optical macromolecular material layer to form an optical film layer corresponding to the template.

### BRIEF DESCRIPTION OF DRAWINGS

FIG. 1 is a schematic structural view of a typical display substrate;

FIG. 2 illustrates schematic waveform diagrams showing the transmittance curves of light transmitted through the typical display substrate as shown in FIG. 1;

FIG. 3 is a schematic structural view of a display substrate provided by embodiments of the present disclosure;

FIG. 4 is a schematic view showing phase changes which take place when light is transmitted through a region covered by an optical film layer and a region not covered as provided by embodiments of the present disclosure;

FIG. 5 illustrates schematic waveform diagrams showing the transmittance curves of light transmitted through the display substrate provided by embodiments of the present disclosure;

FIG. 6a is a schematic structural view of another display substrate provided by embodiments of the present disclosure;

FIG. 6b illustrates schematic waveform diagrams showing the transmittance curves of light transmitted through another display substrate provided by embodiments of the present disclosure;

FIG. 6c is a schematic structural view of a further display substrate provided by embodiments of the present disclosure;

FIG. 7a is a schematic structural view of yet another display substrate provided by embodiments of the present disclosure;

FIG. 7b illustrates schematic waveform diagrams showing the transmittance curves of light transmitted through a further display substrate provided by embodiments of the present disclosure;

FIG. 8a is a schematic structural view of another display substrate provided by embodiments of the present disclosure;

FIGS. 8b-8d are schematic curve diagrams showing the relationship between the viewing angle and the wavelength offset after light is transmitted through the display substrate as provided by embodiments of the present disclosure, respectively;

FIG. 9 is a flow chart showing a manufacturing method of the display substrate provided by embodiments of the present disclosure;

FIGS. 10a-10e are schematic views showing the manufacturing process of the display substrate provided by embodiments of the present disclosure, respectively.

### DETAILED DESCRIPTION

Specific implementations of the display substrate and the manufacturing method thereof as provided by embodiments of the present disclosure are described in detail below with reference to the accompanying drawings.

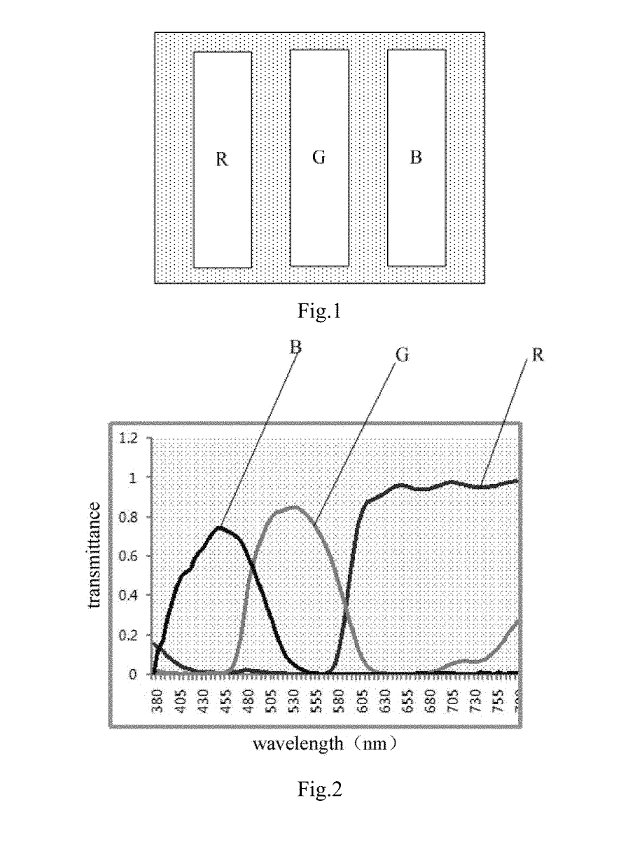

FIG. 1 is a schematic structural view of a typical color filter substrate. As shown in FIG. 1, the peak width of light is wide after it is transmitted through a color filter resin layer due to the limitation of the resin layer (including resin materials of R, G and B colors) itself on the color filter substrate, as shown in FIG. 2. The peak width of red light R after it is transmitted through the resin layer on the color filter is as high as 200 nm, thus the color gamut range of the display device is greatly limited due to the wide peak width, which bottlenecks the improvement in the color gamut of the display device. In such a color filter substrate, the manufacturing process of the color filter substrate is complicated, the manufacturing cost thereof is high, and the color gamut of the display device is limited by the material of the color filter resin layer on the color filter substrate.

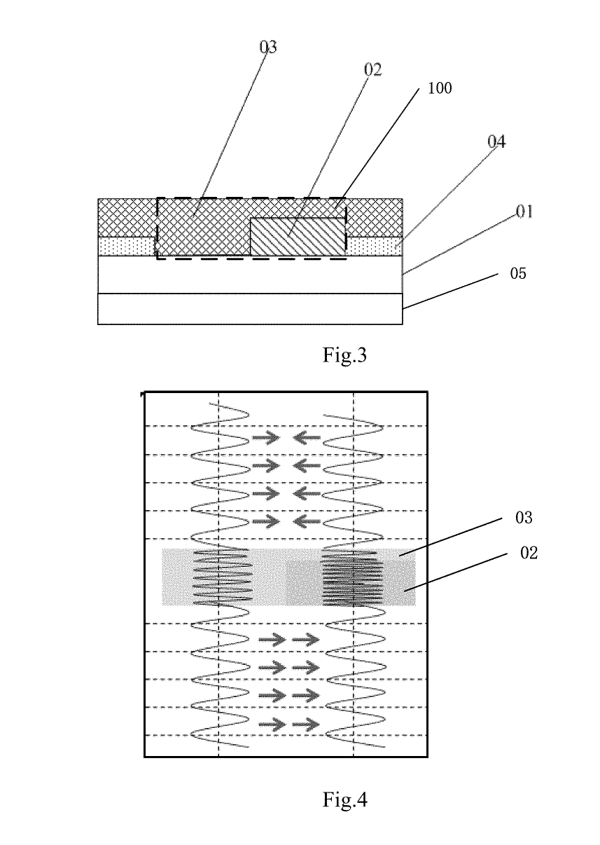

Accordingly, embodiments of the present disclosure provide a display substrate which may comprise: pixel regions 100 on a base substrate 01 corresponding to different wavelengths; an optical film layer 02 in a corresponding pixel region 100, as shown in FIG. 3. For each pixel region 100, the optical film layer 02 is configured such that light exiting from the pixel region 100 has at least two different phases, and the at least two different phases cause light having a wavelength corresponding to the pixel region 100 to interfere constructively, and light having other wavelengths to interfere destructively. Specifically, as shown in FIG. 3, it is possible to make the optical film layer 02 cover only a part of the corresponding pixel region 100.

The display substrate may further comprise a black matrix 04 surrounding each pixel region 100, and a protective layer 03 covering the black matrix 04 and each pixel region 100.

In the above display substrate provided by embodiments of the present disclosure, by making the optical film layer cover only a part of each pixel region, light exiting from the pixel region can have different optical paths. When light of certain wavelengths passes through the pixel region, a portion of light that passes through the optical film layer and a portion of light that does not pass through the optical film layer (i.e. a portion that passes through the pixel region which has a protective layer but does not have an optical film layer) have a phase difference. That is, light passing through the two regions would produce different phase changes, and is thus superposed constructively or destructively, so that light of certain wavelengths cannot be transmitted through the display substrate. It is possible to enable red light, green light and blue light to be transmitted through the display substrate respectively by adjusting the thickness of the optical film layer. Therefore, the display substrate does not need to use resin dyes of R, G and B colors, but only has some requirements on the transmittance and the refractive index of the material used for the optical film layer, thus the manufacturing process and the cost can be decreased. In addition, by controlling the thickness of the optical film layer, the waveform widths of light of different wavelengths after being transmitted through R, G and B pixel regions can be greatly reduced, thereby improving the display color gamut.

According to an exemplary embodiment, in the above display substrate provided by embodiments of the present disclosure, the part covered by the optical film layer and the part not covered by the optical film layer in each pixel region are equal in area. That is, in each pixel region, the part covered by the optical film layer and the part not covered by the optical film layer occupy 50% of the pixel region, respectively. Such manufacturing process is relatively simple, and use of the optical film layer instead of R, G and B resin dyes to achieve the light filtering function of the display substrate can simplify the manufacturing process and reduce the production cost. The optical film layer may have a shape of a strip, a circle, a checkerboard or other shapes that can be made, wherein the strip is relatively easy to make.

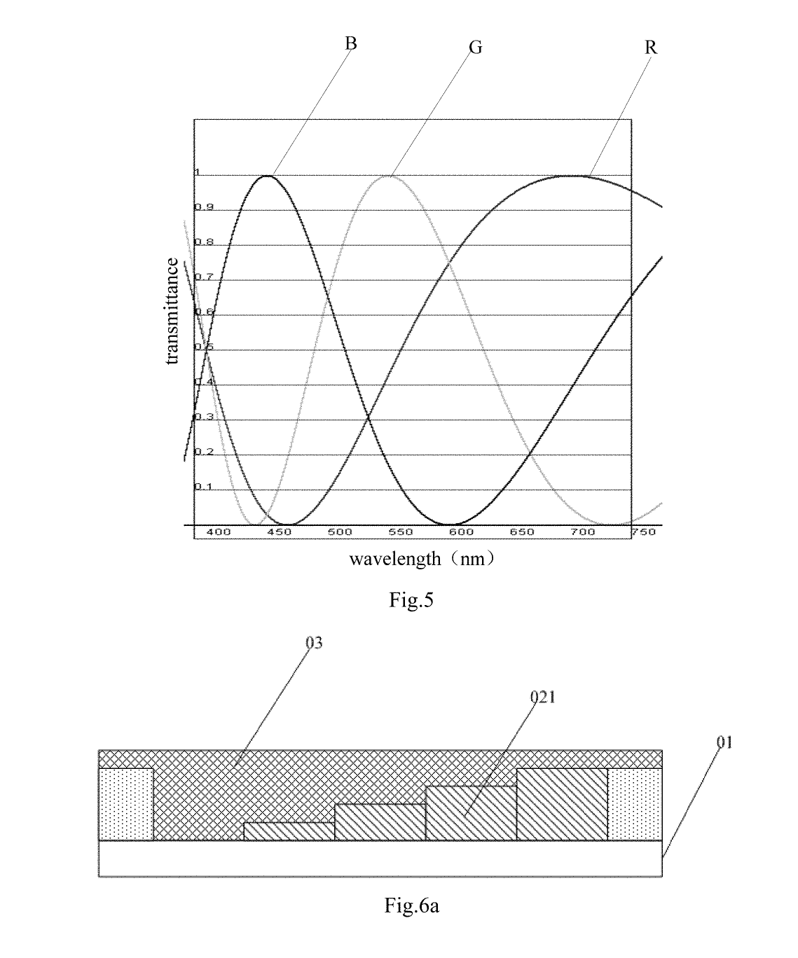

According to an exemplary embodiment, in the above display substrate provided by embodiments of the present disclosure, the display substrate may comprise pixel regions of red, green and blue colors. The thickness of the optical film layer of a red pixel region is 7 μm, the thickness of the optical film layer of a green pixel region is 5.5 μm, and the thickness of the optical film layer of a blue pixel region is 4.3 μm. Specifically, each pixel region may be divided into two parts, one part of which is covered by the optical film layer and the other part of which is not covered by the optical film layer but covered by a protective layer, as shown in FIG. 4. Light passing through these two parts would produce different phase changes, and is thus superposed constructively or destructively. When the refractive index of the material selected for the optical film layer is 1.3, the refractive index of the protective layer is 1.2, and the thickness of the optical film layer of the red pixel region is 7 μm, the peak of light transmitted through the pixel region is 700 nm. When the thickness of the optical film layer of the green pixel region is 5.5 μm, the peak of light transmitted through the pixel region is 550 nm. When the thickness of the optical film layer of the blue pixel region is 4.3 μm, the peak of light transmitted through the pixel region is 430 nm. FIG. 5 is a schematic view showing the simulated transmittance curves of light transmitted through the pixel regions B, G and R which are only partly covered by the optical film layers. As shown in FIG. 5, in the blue pixel region B, the transmittance of light having a wavelength around 430 nm (i.e. blue light) is close to 1, in the green pixel region G, the transmittance of light having a wavelength around 550 nm (i.e. green light) is close to 1, and in the red pixel region R, the transmittance of light having a wavelength around 700 nm (i.e. red light) is close to 1. It is possible to achieve the transmission of light of different wavelengths by disposing optical film layers with different thicknesses in the pixel regions of respective colors, respectively, thereby achieving color display.

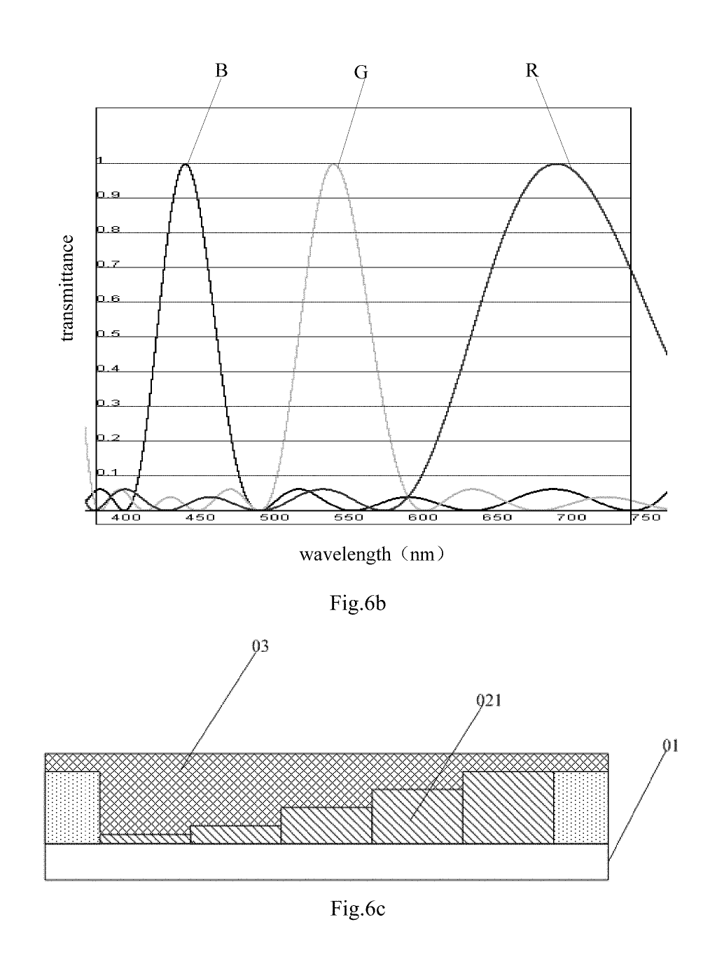

According to an exemplary embodiment, in the above display substrate provided by embodiments of the present disclosure, as shown in FIG. 6a, the optical film layer in each pixel region comprises a plurality of sub-optical film layers 021 with different thicknesses, and two adjacent sub-optical film layers 021 have the same difference in thickness. Specifically, in order to improve the color gamut of a display product, it is necessary to make the waveform of the transmittance curve of light after it is transmitted through the display substrate narrower. Therefore, each pixel region on the display substrate may be equally divided. For example, as shown in FIG. 6a, each pixel region may be equally divided into five sub-regions. The first sub-region is not covered by an optical film layer, that is, the thickness of the sub-optical film layer of the first sub-region is 0. The second sub-region to the fifth sub-region are covered successively by sub-optical film layers having the same difference in thickness. For example, it is assumed that the display substrate includes a red pixel region, a green pixel region, and a blue pixel region, the refractive index of the optical film layer is n1, and the refractive index of the protective layer is n0. Taking the green pixel region as an example, the thicknesses (in μm) of the sub-optical film layers covering the first sub-region to the fifth sub-region are 0, 1100/|n1-n0|, 2200/|n1-n0|, 3300/|n1-n0|, and 4400/|n1-n0|, respectively.

FIG. 6b is a schematic view showing the transmittance curves of light after it is transmitted through the display substrate as shown in FIG. 6a, wherein the optical film layer of the green pixel region is set as a stepped structure as shown in FIG. 6a. As can be seen from FIG. 6b, the waveform width of the transmittance curve of the transmitted green light is reduced to about 100 nm. It can be seen that it is possible to make the waveform width of the transmitted light narrower by designing the optical film layer covering the pixel region to be a stepped structure, thereby improving the color gamut.

It is to be noted that the thickness of the sub-optical film layer of the first sub-region may not be zero, either, as shown in FIG. 6c.

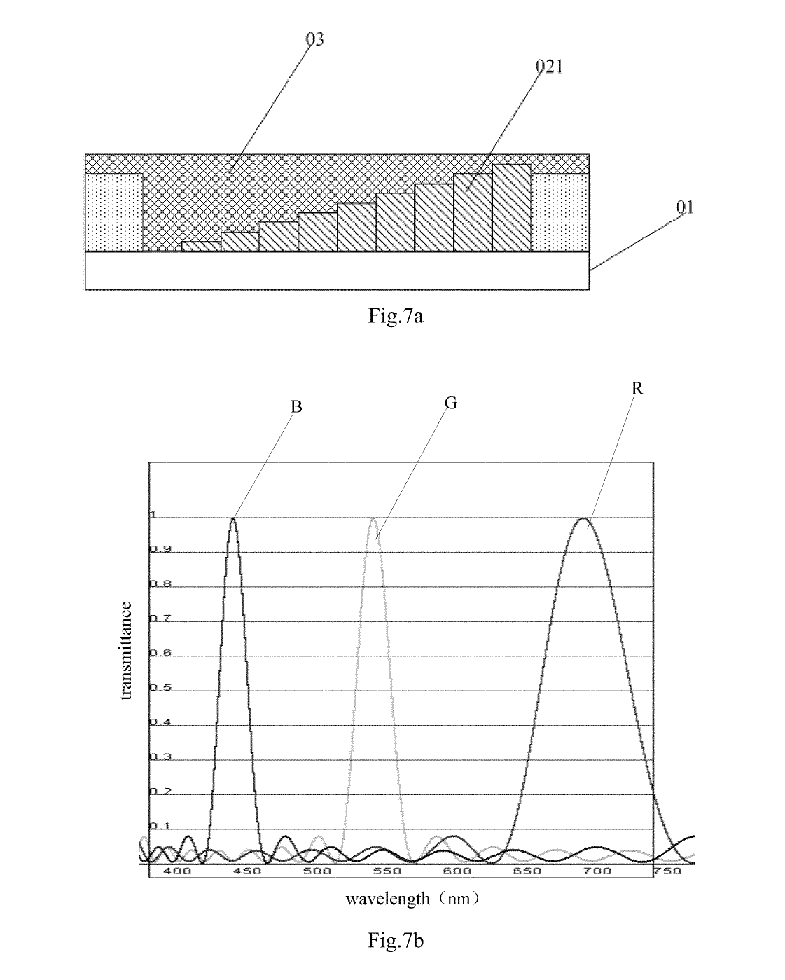

According to an exemplary embodiment, each pixel region may also be equally divided into ten sub-regions, each sub-region is also provided with an optical film layer with a different thickness, and the optical film layer of the first sub-region is zero. Specifically, it is assumed that the display substrate comprises a red pixel region, a green pixel region, and a blue pixel region, the refractive index of the optical film layer is n1, and the refractive index of the protective layer is n0. Taking the green pixel region as an example, as shown in FIG. 7a, the thicknesses (in μm) of the sub-optical film layers covering the first sub-region to the tenth sub-region are 0, 1100/|n1-n0|, 2200/|n1-n0|, 3300/|n1-n0|, 4400/|n1-n0|, 5500/|n1-n0|, 6600/|n1-n0|, 7700/|n1-n0|, 8800/|n1-n0|, and 9900/|n1-n0|, respectively.

FIG. 7b is a schematic view showing the transmittance curves of light after it is transmitted through the display substrate, wherein the optical film layer of the green pixel region is set as a stepped structure as shown in FIG. 7a. As shown in FIG. 7b, the waveform width of the transmittance curve of the transmitted green light is reduced to about 50 nm. It can be seen that it is possible to make the waveform width of the transmitted light narrower by designing the optical film layer covering the pixel region to be a stepped structure, thereby improving the color gamut.

According to an exemplary embodiment, in the above display substrate provided by embodiments of the present disclosure, the regions occupied by the respective sub-optical film layers are equal in area. Specifically, in order to improve the color gamut, each pixel region may be equally divided into a plurality of sub-regions, and different sub-regions are provided with optical film layers with different thicknesses so as to reduce the waveform width of the light transmittance curve. At the same time, making the sub-regions equal in area may facilitate design and fabrication. The sub-optical film layer of each sub-region may be designed in the shape of a strip, a circle, a checkerboard, or other shapes that can be made, wherein the strip design is relatively easy to achieve.

According to an exemplary embodiment, in the above display substrate provided by embodiments of the present disclosure, the refractive indices of the protective layer and the optical film layer are close to that of the glass substrate, and the difference between the refractive indices of the optical film layer and the protective layer may range from about 0.1 to 0.2. This may prevent the refraction angle from affecting the optical path. A portion of light that passes through the optical film layer and a portion of light that does not pass through the optical film layer (a portion of light that passes through the protective layer) have a phase difference. That is, light passing through the two regions would produce different phase changes, and is thus superposed constructively or destructively, so that light of certain wavelengths cannot be transmitted through a specific region of the display substrate.

According to an exemplary embodiment, in the above display substrate provided by embodiments of the present disclosure, the optical film layer may be a high molecular polymer with anisotropy.

Returning to FIG. 3, as shown in FIG. 3, the above display substrate provided by embodiments of the present disclosure may further comprise a polarizer 05 on the light emergent side of the display substrate. The polarizer 05 is a wide viewing angle polarizer. Specifically, when light passes through the display substrate at an angle θ (θ≠90°), the optical path difference will change, which results in color shift in the display device, causing the viewing angle to be too small. Therefore, an anisotropic high molecular polymer material having different dielectric constants in various directions can be used to make the optical film layer, which can effectively improve color shift. Moreover, the problem of a too small viewing angle can be solved by employing a wide viewing angle polarizer on the light emergent side of the display substrate. The polarizer makes the exit light linearly polarized. The influence of the refraction angle on the optical path can be neglected by selecting the protective layer material and the optical film layer material which have similar refractive indices to the glass substrate.

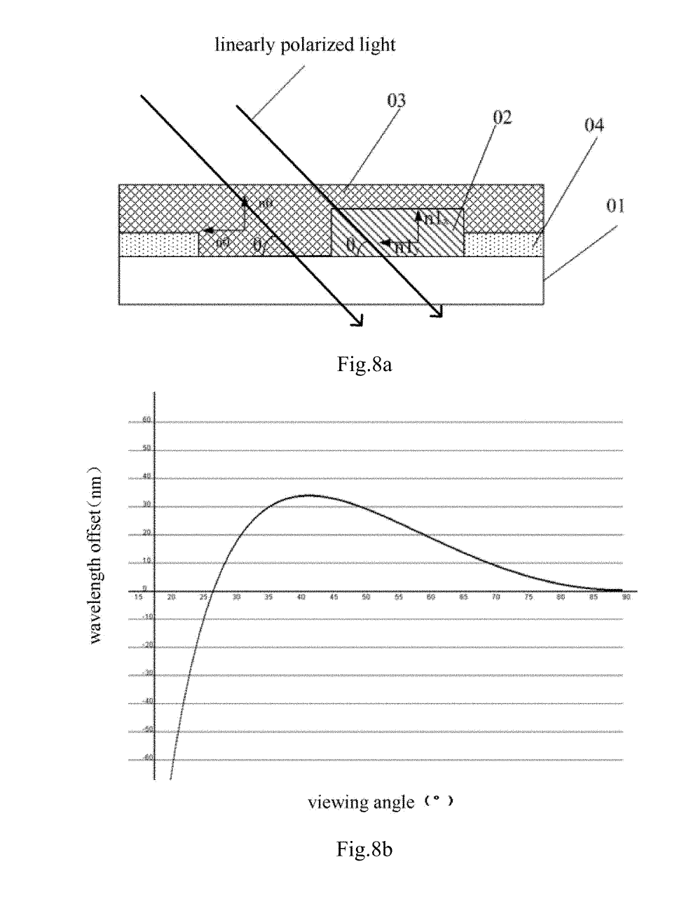

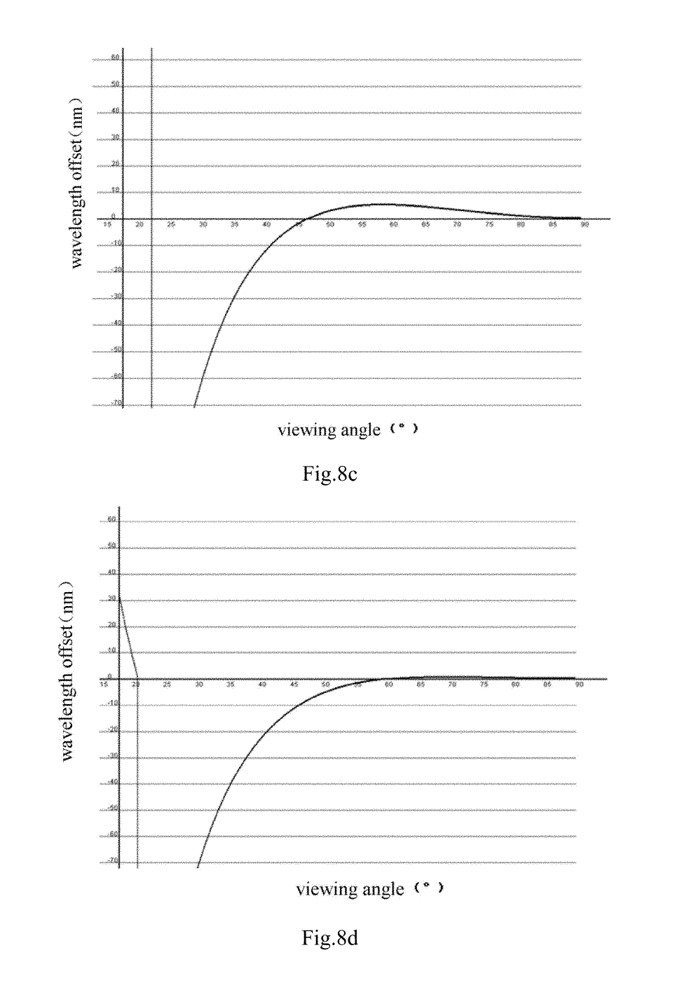

As shown in FIG. 8a, the arrows denote the light emergent direction. When an optical film layer material whose refractive index is about n1ₓ=1.27 and n1_{y}=1.2 and a protective layer material whose refractive index is about n0=1.3 are selected, as shown in FIG. 8b, the absolute value of the maximum offset of the peak of the light transmittance curve within a viewing angle range of 25° is about 30 nm, which falls within an acceptable range of human eyes so that normal displayed images can be viewed.

According to an exemplary embodiment, the refractive index of the optical film layer may be further adjusted so as to reduce color shift, ensure a high color gamut, and achieve high-precision color display. Specifically, when an optical film layer material whose refractive index is about n1ₓ=1.26 and b1_{y}=1.2 and a protective layer material whose refractive index is about n0=1.3 are selected, as shown in FIG. 8C, the absolute value of the maximum offset of the peak of the light transmittance curve within a viewing angle range of 45° is about 6 nm. When an optical film layer material whose refractive index is about n1ₓ=1.22 and n1_{y}=1.1 and a protective layer material whose refractive index is about n0=1.3 are selected, as shown in FIG. 8d, the absolute value of the maximum offset of the peak of the light transmittance curve within a viewing angle range of 55° is about 1 nm.

It can be seen from a comparison between the simulated curves that color shift can be reduced by adjusting the refractive index of the optical film layer so as to ensure a high color gamut. In addition, in a backlight module of a display product, a prism sheet can also be used to condense light beams, which cooperates with the wide viewing angle polarizer on the light emergent side of the display substrate so as to increase the viewing angle on the basis of ensuring a high color gamut.

Based on the same inventive concept, embodiments of the present disclosure provide a display panel comprising any of the display substrates described above.

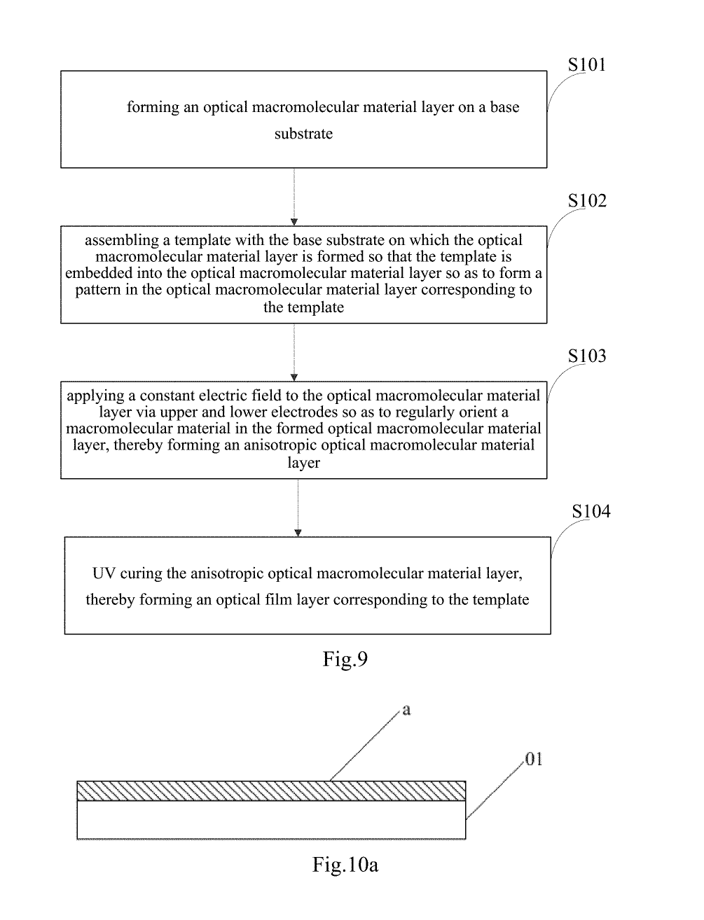

Based on the same inventive concept, embodiments of the present disclosure further provide a manufacturing method of the above display substrate provided by embodiments of the present disclosure. As shown in FIG. 9, the manufacturing method of the display substrate may comprise the steps of:

at step S101, forming an optical macromolecular material layer on a base substrate;

at step S102, assembling a template with the base substrate on which the optical macromolecular material layer is formed so that the template is embedded into the optical macromolecular material layer so as to form a pattern in the optical macromolecular material layer corresponding to the template;

at step S103, applying a constant electric field to the optical macromolecular material layer via upper and lower electrodes so as to regularly orient a macromolecular material in the formed optical macromolecular material layer, thereby forming an anisotropic optical macromolecular material layer; and

at step S104, UV curing the anisotropic optical macromolecular material layer, thereby forming an optical film layer corresponding to the template.

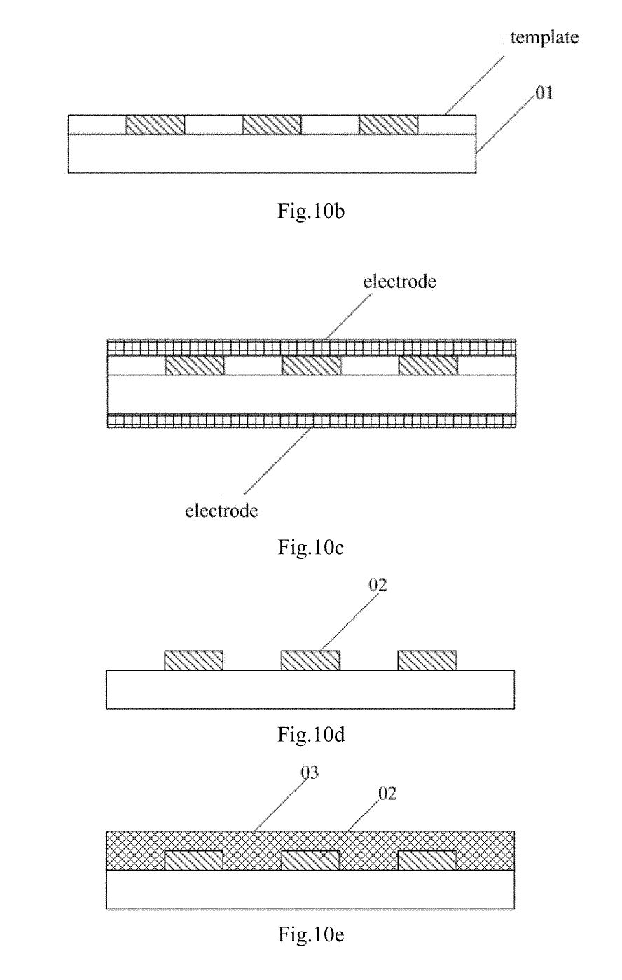

Specifically, as shown in FIG. 10a, an optical film layer a may be formed on a glass substrate, i.e. a base substrate 01. Then, as shown in FIG. 10b, a template made of a rigid non-conductive material is assembled with the base substrate 01 on which the optical film layer a is formed, so that the template is embedded into the optical film layer a to form a pattern in the optical film layer a corresponding to the template. Next, as shown in FIG. 10c, a constant electric field is applied to the optical film layer a via upper and lower electrodes so as to regularly orient a macromolecular material in the formed optical film layer a, thereby forming an anisotropic structure to make the optical film layer anisotropic. Next, as shown in FIG. 10d, an optical film layer 02 having the anisotropic structure is UV cured to form an optical film layer 02 corresponding to the template. Finally, as shown in FIG. 10e, a protective layer 03 is formed over the formed optical film layer 02.

Embodiments of the present disclosure provide a display substrate and a manufacturing method thereof The display substrate comprises: pixel regions corresponding to different wavelengths; an optical film layer in a corresponding pixel region. For each pixel region, the optical film layer is configured such that light exiting from the pixel region has at least two different phases, and the at least two different phases cause light having a wavelength corresponding to the pixel region to interfere constructively, and light having other wavelengths to interfere destructively. By making the optical film layer have different thicknesses, light exiting from the pixel region can have different optical paths. When light of certain wavelengths passes through the pixel region, portions of light which pass through the optical film layers with different thicknesses have phase differences. That is, light passing through the two regions would produce different phase changes, and is thus superposed constructively or destructively, so that light of certain wavelengths cannot be transmitted through the display substrate. It is possible to enable red light, green light and blue light to be transmitted through the display substrate respectively by adjusting the thickness of the optical film layer. Therefore, the display substrate does not need to use resin dyes of R, G and B colors, but only has some requirements on the transmittance and the refractive index of the material used for the optical film layer, thus the manufacturing process and the cost can be decreased. In addition, by controlling the thickness of the optical film layer, the waveform widths of light of different wavelengths after being transmitted through R, G and B pixel regions can be greatly reduced, thereby improving the display color gamut.

It is to be noted that, although the concept of the present disclosure is explained based on the example of a display substrate comprising R, G and B pixel regions, the concept of the present disclosure is also applicable to display substrates which employ other color schemes, for example, a display substrate comprising R, G, B and W pixel regions.

It is to be further noted that, although the examples in which each of the pixel regions is equally divided into two portions, five portions and ten portions are enumerated illustratively, the concept of the present disclosure is not limited thereto. The pixel region can be divided by those skilled in the art according to actual needs.

Obviously, those skilled in the art can make various modifications and variations to the present disclosure without departing from the spirit and scope thereof. In this way, if these modifications and variations to the present disclosure pertain to the scope of the claims of the present disclosure and equivalent technologies thereof, the present disclosure also intends to encompass these modifications and variations.

1. A display substrate, comprising:
pixel regions corresponding to different wavelengths;
an optical film layer in a corresponding pixel region;
wherein, for each pixel region,
the optical film layer is configured such that light exiting from the pixel region has at least two different phases, and
the at least two different phases cause light having a wavelength corresponding to the pixel region to interfere constructively, and light having other wavelengths to interfere destructively.

2. The display substrate according to claim 1, wherein the optical film layer covers only a part of the corresponding pixel region.

3. The display substrate according to claim 2, wherein in each pixel region, the part covered by the corresponding optical film layer and a part not covered by the corresponding optical film layer are substantially equal in area.

4. The display substrate according to claim 2, comprising a red pixel region, a green pixel region, and a blue pixel region,
wherein,
an optical film layer corresponding to the red pixel region has a thickness of about 7 μm;
an optical film layer corresponding to the green pixel region has a thickness of about 5.5 μm;
an optical film layer corresponding to the blue pixel region has a thickness of about 4.3 μm.

5. The display substrate according to claim 1, wherein each pixel region comprises a plurality of sub-regions, and each sub-region is covered with a sub-optical film layer with a different thickness.

6. The display substrate according to claim 5, wherein differences in thickness between sub-optical film layers corresponding to every two adjacent sub-regions are substantially the same.

7. The display substrate according to claim 5, wherein the sub-regions are substantially equal in area.

8. The display substrate according to claim 7, further comprising:
a black matrix surrounding each pixel region; and
a protective layer covering the black matrix and each pixel region.

9. The display substrate according to claim 8, wherein each pixel region is equally divided into five sub-regions, a sub-optical film layer corresponding to a first sub-region has a thickness of 0, and from the first sub-region to a fifth sub-region, the thicknesses of corresponding sub-optical film layers successively increase with a substantially constant step.

10. The display substrate according to claim 9, comprising a red pixel region, a green pixel region and a blue pixel region, wherein a refractive index of the optical film layer is n1, a refractive index of the protective layer is n0, and in the green pixel region, thicknesses of the sub-optical film layers covering the first sub-region to the fifth sub-region are 0, 1100 μm/|n1-n0|, 2200 μm/|n1-n0|, 3300 μm/|n1-n0|, and 4400 μm/|n1-n0|, successively.

11. The display substrate according to claim 8, wherein each pixel region is equally divided into ten sub-regions, a sub-optical film layer corresponding to a first sub-region has a thickness of 0, and from the first sub-region to a tenth sub-region, the thicknesses of corresponding sub-optical film layers successively increase with a substantially constant step.

12. The display substrate according to claim 11, comprising a red pixel region, a green pixel region, and a blue pixel region, wherein a refractive index of the optical film layer is n1, a refractive index of the protective layer is n0, and in the green pixel region, thicknesses of the sub-optical film layers covering the first sub-region to the tenth sub-region are 0, 1100 μm/|n1-n0|, 2200 μm/|n1-n0|, 3300 μm/|n1-n0|, 4400 μm/|n1-n0|, 5500 μm/|n1-n0|, 6600 μm/|n1-n0|, 7700 μm/|n1-n0|, 8800 μm/|n1-n0|, and 9900 μm/|n1-n0|, successively.

13. (canceled)

14. The display substrate according to claim 5, wherein the sub-optical film layer has a shape selected from a group comprising a strip, a circle and a checkerboard.

15. The display substrate according to claim 8, wherein a difference between refractive indexes of the optical film layer and the protective layer ranges from about 0.1 to 0.2.

16. (canceled)

17. The display substrate according to claim 1, wherein the optical film layer is a high molecular polymer having anisotropy.

18. The display substrate according to claim 17, further comprising a polarizer on a light emergent side of the display substrate,
wherein the polarizer is a wide viewing angle polarizer.

19. The display substrate according to claim 1, wherein the display substrate is a color filter substrate.

20. The display substrate according to claim 1, wherein the display substrate is an array substrate.

21. A display panel, comprising the display substrate according to claim 1.

22. A manufacturing method of the display substrate according to claim 1, comprising:
forming an optical macromolecular material layer on a base substrate;
assembling a template with the base substrate on which the optical macromolecular material layer is formed so that the template is embedded into the optical macromolecular material layer to form a pattern in the optical macromolecular material layer corresponding to the template;
applying a constant electric field to the optical macromolecular material layer via upper and lower electrodes so as to regularly orient a macromolecular material in the formed optical macromolecular material layer to form an anisotropic optical macromolecular material layer; and
UV curing the anisotropic optical macromolecular material layer to form an optical film layer corresponding to the template.
